(19) United States
(12) Patent Application Publication
(10) Pub. No.: US 2022/0171656 A1
(43) Pub. Date: Jun. 2, 2022

(54) ADJUSTABLE-PRECISION MULTIDIMENSIONAL MEMORY ENTROPY SAMPLING FOR OPTIMIZING MEMORY RESOURCE ALLOCATION

(71) Applicant: UNIFABRIX LTD., Haifa (IL)

(72) Inventors: Ronen Aharon HYATT, Haifa (IL); Danny Volkind, Nesher (IL)

(73) Assignee: UNIFABRIX LTD., Haifa (IL)

(21) Appl. No.: 17/540,483

(22) Filed: Dec. 2, 2021

Related U.S. Application Data
(60) Provisional application No. 63/120,267, filed on Dec. 2, 2020.

(51) Int. Cl. G06F 9/50; G06F 9/46; G06F 7/58; G06F 1/08

(52) U.S. Cl. CPC G06F 9/5016; G06F 9/5022; G06F 1/08; G06F 7/588; G06F 9/467

(57) ABSTRACT

Managing memory resources in a computing system may include receiving, from a computing system, data associated with memory transaction events originating from a process executing on the computing system; storing data related to memory transactions in multiple data structures according to metadata related to past memory transactions events; and altering memory storage or determining memory address translations based on the stored data.

### PRIOR APPLICATION DATA

The present application claims benefit from prior provisional application 63/120,267 filed on Dec. 2, 2020, entitled ADJUSTABLE-PRECISION MULTIDIMENSIONAL MEMORY ENTROPY SAMPLING, incorporated by reference herein in its entirety.

### FIELD OF THE INVENTION

The present invention relates generally to management and monitoring of memory resources in a computing system.

### BACKGROUND OF THE INVENTION

Modern computing architectures use multiple layers of address spaces, for example to abstract underlying structures, provide security and isolation (e.g., per process or per guest virtual machine (VM) from an underlying hypervisor), or simplify programming (e.g., by means of independent selection of memory addresses).

A variety of mechanisms exist for implementing and accelerating address mappings and address translations between layers. A few representative examples of such mechanisms in a modern Memory Management Unit (MMU) include the use of Page Tables (PTs), Page-Table Walkers (PTWs), Translation Caches, Page Table Caches, Translation Lookaside Buffers (TLBs), and numerous forms of lookup tables. Additional address mapping and translation mechanisms exist in closely related domains, such as in storage systems. Examples include: FTL (Flash Translation Layer), LBA (Logical Block Addressing) to CHS (Cylinder/Head/Sector) and LBA to PBA (Physical Block Address).

The process of address mapping and translation is commonly performed at coarse-granularity of relatively large chunks (such as pages/blocks/frames etc.), where the ultimate fine-grain target address includes the coarse-grained translation coupled with an offset (normally in Byte granularity). Such large chunks may come in equal sizes (e.g., 4 KB pages) or in varying sizes (e.g., plurality of custom address regions).

In recent years, the vast use of “big data” applications, large databases, and other types of applications that require enormous amounts of memory and storage, have induced significant stress on the various address mapping and translation mechanisms. For instance, the significant increase in system memory from dozens of gigabytes (GBs) to several terabytes (TBs), accompanied by reduced locality patterns in modern workloads, has reduced the effectiveness of translation mechanisms such as TLBs and other translation caches in the MMU. In particular, TLB size has not scaled up in proportion to the increase in system memory size, mainly due to the associated silicon and power costs involving such increase. Consequently, in some systems the effectiveness of the TLB has degraded, causing more TLB-misses that require much slower page-table walks, thus affecting the overall performance of the system.

A possible workaround to remedy this situation uses large pages (which, in certain architectures, may correspond to 2 MB or 1 GB pages instead of the traditional 4 KB pages). Such a workaround dramatically increases the TLB reach and reduces TLB misses, providing significant performance gains to the system in the context of demanding modern workloads.

However, an increase in page size is known to affect related important mechanisms. In particular, it reduces OS (or functionally similar entities) visibility into the usage patterns of memory and the distribution of hot spots across the memory space. Accurate sampling of such hot spot levels is an essential component in many system-level algorithms that offer improved memory usage by redistributing the corresponding memory resources as needed (such that optimal hot spot levels are achieved)

In one common implementation, for instance, the operating system (OS) would periodically review Page Table Entries (PTEs) and evaluate per-page indications such as A(Access) and D(Dirty) bits—which may be seen as a coarse-grained hot spot sampling method. The OS would then seek to classify pages as “hot” or “cold” according to their usage patterns, and further evict “cold” pages from main memory into lower hierarchies of memory and/or storage (e.g., into remote memory). By evicting “cold” pages that are less frequently used (resulting in, e.g., page-outs), the OS makes room for more important data which is more frequently used. Whereas the use of smaller 4 KB pages provides the OS with relatively fair fine-grained visibility when classifying “hot” and “cold” pages13 the shift to much larger pages (e.g., 2 MB, 1 GB, etc.) leads to significant loss of visibility and prevents the OS from having a fine-grained view on memory entropy distributions. As an example, a large page would be considered hot and will be kept in main memory even if only a small fraction of this Large Page is actually accessed and used—therefore leading to memory bloating.

Regardless of their implementations in hardware, firmware, or software, existing memory management architectures interlink the precision of memory address translation with the precision of hot spot sampling. Such coupling makes it difficult and oftentimes infeasible to uncover usage patterns of memory, such as: spatial and temporal localities that may assist in predicting imminent events; asymmetrical entropy distributions that might lead to inefficient resource utilization; accumulation of heat in hot spots due to excessive use; and degradation in reliability due to excessive and uneven wear of the memory elements.

### SUMMARY OF THE INVENTION

A computer based system and method for managing memory resources in a computing system may include receiving, from a computing system, data associated with memory transaction events originating from a process executing on the computing system; storing data related to memory transactions in multiple data structures according to metadata related to past memory transactions events; and altering memory storage or determining memory address translations based on the stored data.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high-level block diagram of an exemplary computing device according to some embodiments of the present invention.

FIGS. 2 and 3 are block diagrams of example computer architectures that may be used in some embodiments of the present invention.

FIG. 4 illustrates an example entropy sampling apparatus in a processor core, an internal structure for a multidimensional entropy sampling (MDES) engine, and an entropy store implementation to be stored in system memory according to some embodiments of the invention.

FIG. 5 is a block diagram of policy table components which may be used in an entropy sampling apparatus, and an illustration of an entropy sampling procedure according to possible embodiments of the invention.

FIG. 6 is a flow diagram illustrating the triggering of software defined policies and policy actions via policy keys—that may be used, e.g., as part of an entropy data collection process according to some embodiments of the present invention.

FIG. 7 is a flow diagram illustrating a periodic entropy sampling process involving the triggering of software defined policies according to some embodiments of the present invention.

FIG. 8 illustrates an example where MDES engine is configured to track power consumption estimates for particular memory components, for the purpose of monitoring system health and prevent hot spots that might cause premature failures, according to some embodiments of the invention.

FIG. 9 is a flowchart depicting a process of managing memory resources in a computing system according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

When discussed herein, “a” computer processor performing functions may mean one computer processor performing the functions or multiple computer processors or modules performing the functions; for example, a process as described herein may be performed by one or more processors, possibly in different locations.

Embodiments may capture or intercept memory transactions (e.g. read or write), and record the transactions or data related to the transactions, for example in a journal, based on metadata related to the transaction [e.g. process ID (identification) related to the transaction, memory address, etc.]. A single transaction may be saved in multiple data journals, each different journal possibly dealing with a different issue. The data saved in journals may then be used by, system monitoring module or entity, in order to react to future memory transactions, or to calculate data (e.g. entropy, memory “heat” or usage, or future usage patterns of memory resources) used to alter memory storage, allocation, address translation, or policies or rules: for example a memory transaction may he delayed or throttled based on the transaction, a policy, and metadata saved in journal entries; and based on a policy, and meta.data saved in journal entries, memory storage may be altered, moved or reallocated. Similarly, memory pages or memory chunks of various sizes may be moved, or migrated, from one location to another—e.g., from remote memory to local memory, or from one memory-media type (e.g., persistent memory) to another memory-media type (e.g., DRAM), such that a desirable memory redistribution (which may accelerate the system's performance) is achieved. For example, a system monitoring module may be used for reading and analyzing data saved in journals and for determining that particular memory resources or components are accessed in a high rate (e.g., found above a certain safety threshold)—which may lead, for example, to excessive heating of memory components which may, in turn, result in immediate or longer-term. memory robustness and reliability issues. In response, the system monitoring module may, for instance, be used for configuring a memory controller to throttle or limit memory transactions to particular ranges of memory addresses.

In another example, a system monitoring module may be used for reading and analyzing data saved in journals and for determining that a particular virtual machine is accessing memory resources more frequently than its service level agreement (SLA) permits. In response, the system monitoring module may, e.g., react by configuring registers in the memory subsystem that throttle or limit transactions from that particular virtual machine. In yet another example, a different system. monitoring module may be used for detecting frequent accesses from an execution unit (e.g., local CPU core) to remote memory, and respond, for instance, with an instruction to a DMA engine to relocate memory sections (e.g., memory pages), front remote persistent memory to a memory resource such as local DRAM, being tightly coupled with the local execution unit (such that, e.g., memory speed may be optimized).

Other actions may be taken based on data stored in journal entries. Policies, e.g. in the form of rules, may take as input data such as journal data (e.g. describing a history of memory transactions) and/or a transaction, and cause action to be taken, e.g. determining if and where to save transaction or entropy data, or signaling the operating system or a system monitoring module to perform memory related operations such as migrations, throttling, etc., as demonstrated hereinabove. Data structures such as journals may include metadata such as transactor or application ID, virtual machine (VM) ID, or other metadata. Each transaction or data describing each transaction may be saved in multiple different journals. Metadata such as transactor or application ID, virtual machine (VM) ID, or other metadata may also be used to determine which rule is to be applied to a transaction. Different amounts of transactions may be sampled or collected: e.g. all transactions, a certain percentage of transactions, X transactions every time period, etc. Memory or processing related actions such as reallocation, address translation, deciding where to store data, migrations, and throttling (e.g. changing the operational speed of a process), restricting memory access of a process, etc. may be effected by sending a message or request to, for example, the operating system (OS), a system monitoring module or device, or another pre-existing unit. For example, altering memory storage, such as reprovisioning, redirecting storage requests from one storage medium to another, storing transaction request data in a particular or specific memory resources, throttling memory requests, etc. may be based on the data stored in journals, and policies (which may take as input journal data, a specific transaction, metadata associated with memory transaction events or other data). A policy may affect if, how, where, or how often journal data is stored, and may dictate a rate. A rate journal data is stored or sampled may be based on different factors: e.g. the rate data is added to data structures such as journals may be in part due to the output of a random number generator, or a timer or clock ticks.

For example, a policy or rule may when triggered or executed may, for any memory transaction for resource X and address within X, determine or calculate energy consumed for the transaction, sum energy over time for this resource and address based on journal entries, decide the transaction is good or bad, and if bad linear access to this resource, e.g. throttle, as it is too “hot”. A proxy for actual heat may be a measurement of memory accesses: for example heat may be calculated, for instance, by applying a linear mathematical function according to the assumption that each memory access is associated with a certain amount of energy expressed in pico-Joules. In some embodiments of the invention, energy contributions may be collected in a journal and then analyzed by a system monitoring module to further perform memory related actions or operations, such as throttling, restricting memory access of a process, altering memory storage, allocation, address translation, or policies as demonstrated hereinabove. Throttling may include reducing CPU speed, or sending a command or request to a MMU to slow down writing to a certain memory, or limit amount of compute allowed for a certain server rack. A policy may in the case of a tennant (e.g. process or virtual machine) consuming too much memory, affecting other tenants' use of common memory in a cloud computing environment, lead to sampling of entropy data that may, in turn, be used by a system monitoring unit for throttling memory usage of the tennant. Data measured may be multidimensional, e.g. both in in time domain and space domain. Each data point collected may instead of being considered in isolation, used to make a decision in conjunction with other data accumulated over time.

In one embodiment, a memory transaction event (e.g. to read or write a set of data to memory) may be received, and based on data or an item of metadata describing the transaction, which may be taken from the event, and a journal describing a history of memory transactions, in which memory system of a plurality of memory resources or systems to store the data, it may be determined, e.g. where to store the relevant transaction data, to be used by the OS or a system monitoring module in determining if to re-allocate memory, if to modify translation structures, how to serve the transaction (e.g. immediately, slowly, in a throttled manner), if to change a policy or resource allocation for the VM or application requesting the transaction (e.g. to throttle the speed of the VM, to limit the speed of VM access to memory, etc.). A journal may include data related to transaction events, describing a history of memory transactions for a set of memory resources. It is noted that embodiments of the invention may decide both, and separately, where, if and how to store the transaction in a journal for the purpose of documenting past memory transactions; and how to store/access/read the data or memory described by the transaction.

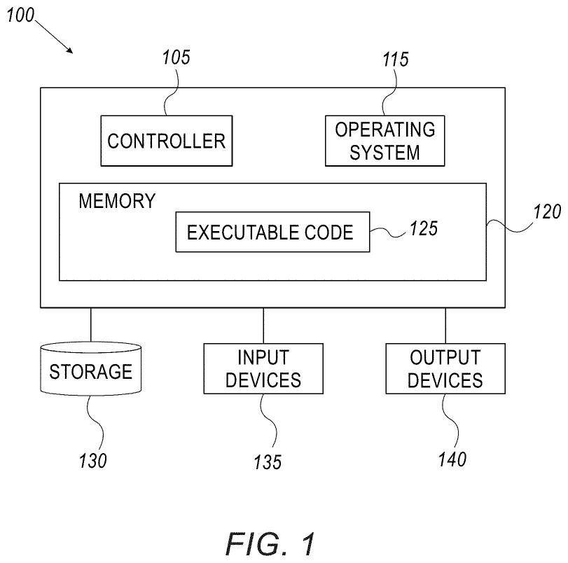

Reference is made to FIG. 1, showing a high-level block diagram of an exemplary computing device according to some embodiments of the present invention. Computing device 100 may include a controller 105 that may be, for example, a central processing unit processor (CPU) or any other suitable multi-purpose or specific processors or controllers, a chip or any suitable computing or computational device, an operating system 115, a memory 120, executable code 125, a storage system 130, input devices 135 and output devices 140. Controller 105 (or one or more controllers or processors, possibly across multiple units or devices) may be configured to carry out methods described herein, and/or to execute or act as the various modules, units, etc. for example when executing code 125. More than one computing device 100 may be included in, and one or more computing devices 100 may be, or act as the components of, a system according to embodiments of the invention. Various components, computers, and modules of FIG. 1 may be or include devices such as computing device 100, and one or more devices such as computing device 100 may carry out functions as described herein.

OS 115 may be or may include any code segment (e.g., one similar to executable code 125) designed and/or configured to perform tasks involving coordination, scheduling, arbitration, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory or storage units. Memory 120 may be or may include a plurality of, possibly different memory units. Memory 120 may be a computer or processor non-transitory readable medium, or a computer non-transitory storage medium, e.g., a RAM. Multiple memories 120 may be included, in different layers, e.g. cache, local memory within a computer (e.g. on the same board or in the same box as the processors); a peripheral memory physically attached to a computer; a remote memory geographically removed from the processor (e.g. cloud computing); or memory in a different computing system (e.g. accessed using remote direct memory access (RDMA) techniques). Memories 120, storage 130, or other memory or storage systems may be memo resources or components affected by methods as discussed herein.

Executable code 125 may be any executable code, e.g., an application, a program, a process, task or script. Executable code 125 may be executed by controller 105 possibly under control of operating system 115. For example, executable code 125 may configure controller 105 to link records from different data sets, form metrics or ratings, display such analysis in preexisting programs, and perform other methods as described herein. Although, for the sake of clarity, a single item of executable code 125 is shown in FIG. 1, a system according to some embodiments of the invention may include a plurality of executable code segments similar to executable code 125 that may be loaded into memory 120 or another non-transitory storage medium and cause controller 105, when executing code 125, to carry out methods described herein.

Storage system 130 may be or may include, for example, a hard disk drive, a CD-Recordable (CD-R) drive, a Blu-ray disk (BD), a universal serial bus (USB) device or other suitable removable and/or fixed storage unit. Data such as commits, issues, etc. may be stored in storage system 130 and may be loaded from storage system 130 into memory 120 where it may be processed by controller 105. Some of the components shown in FIG. 1 may be omitted. For example, memory 120 may be a non-volatile memory having the storage capacity of storage system 130. Accordingly, although shown as a separate component, storage system 130 may be embedded or included in memory 120.

Input devices 135 may be or may include a mouse, a keyboard, a microphone, a touch screen or pad or any suitable input device. Any suitable number of input devices may be operatively connected to computing device 100 as shown by block 135. Output devices 140 may include one or more displays or monitors, speakers and/or any other suitable output devices. Any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a printer, a universal serial bus (USB) device or external hard drive may be included in input devices 135 and/or output devices 140.

In some embodiments, device 100 may include or may be, for example, a personal computer, a desktop computer, a laptop computer, a workstation, a server computer, a network device, or any other suitable computing device. A system as described herein may include one or more devices such as computing device 100.

Memory entropy (which may be referred to as “entropy” herein) may be used to establish measures and assessments of memory related events and activities, such as memory accesses that may affect hit ratios in caches, or that may develop performance bottlenecks and/or hot spots in other parts of the system's memory. Entropy as used herein may generally correspond to all data and/or metadata associated with memory related events such as address translations and memory access transactions. Such data/metadata may include telemetry metadata, for instance, a TimeStamp, NumaID (processor NUMA ID or sub-NUMA ID), CoreID (Processor Core ID), VMid (Virtual Machine ID), PID (Process ID), PASID (Process Address Space ID), gVA (guest Virtual Address), gPA (guest Physical Address), hPA (host Physical Address), DimmID (DIMM memory component ID), and the like. Such metadata may, e.g., not be visible (e.g. known) to OS 115 of computing device 100.

In some embodiments of the invention, telemetry metadata may be collected from internal busses within a hardware execution unit such as a processor core. In some other embodiments, where the execution entity is virtual and implemented purely in software, telemetry metadata may be collected from internal software transaction parameters associated with, e.g., a virtual execution unit such as a vCPU.

While data that is not visible to OS 115 can, in principle, be collected and processed as known in the art (via, e.g., establishing a connection to a cache-coherent interface for monitoring cache snoop operations), there is currently no systematic way of organizing this data such that it can be readily used for multi-purpose assessments of memory related events. Calculations or manipulations on appropriately organized entropy data may thus generally provide insight into memory usage patterns. As a simple example, the number of accesses per a given unit of time for a particular memory address may be used as a relative measure for hot spot detection (e.g., when this measure is compared across many such addresses). Such relative measure may also be employed as part of memory throttling techniques that restrict memory transactions to a particular physical memory resource for the purpose of managing power consumption.

Embodiments may provide a method and apparatus for collecting and storing data/metadata associated with events and transactions related to the memory system with adjustable fine-grain precision. Embodiments of the present invention may provide a method and apparatus for separating the precision of memory address translation from the precision of entropy collection.

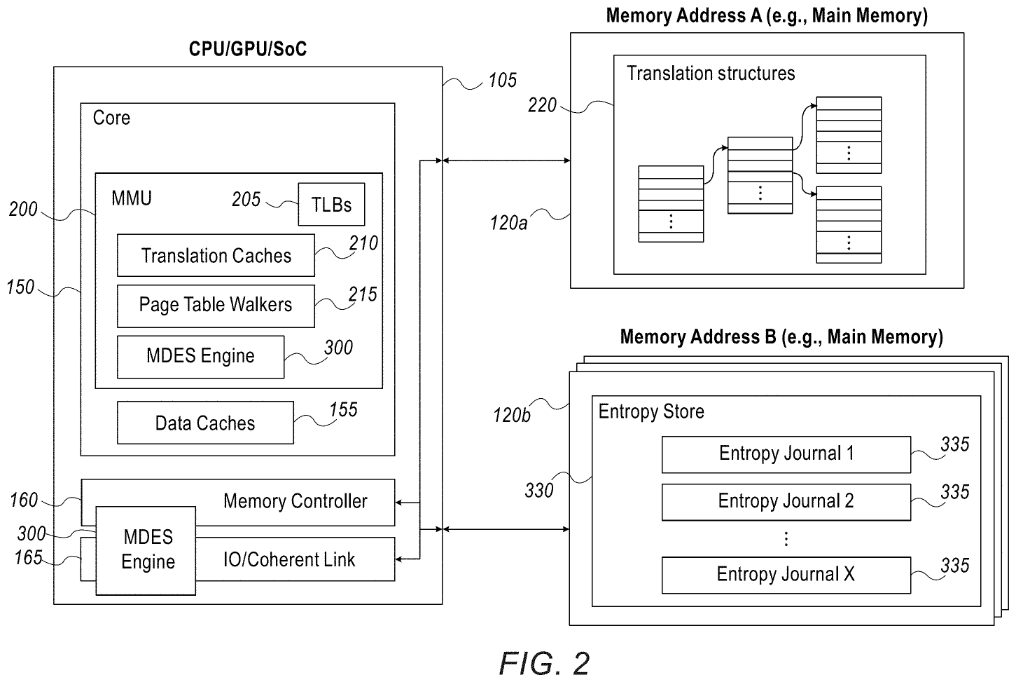

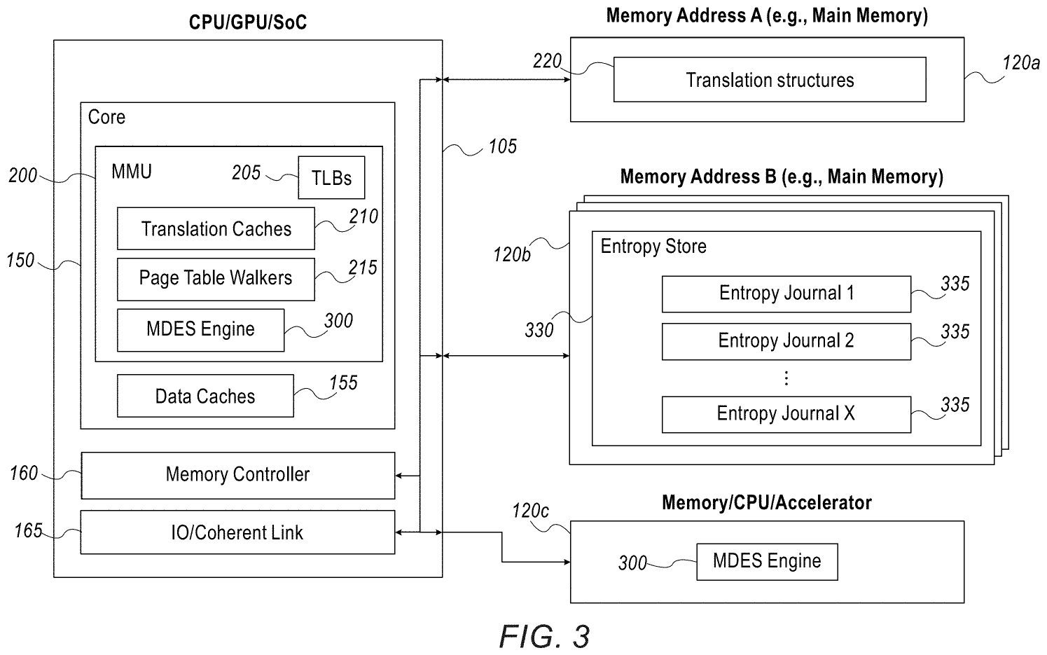

FIGS. 2 and 3 are block diagrams of example computer architectures that may be used in some embodiments of the present invention. Elements of FIGS. 2 and 3 may include computing systems as in FIG. 1. Such architectures may include a processor 105, that may be, for example, a CPU, GPU, system of a chip (SoC), a chip or any suitable computing or computational device, in addition to various memory resources 120 (a, b, etc. designate different such resources). Processor 105 may incorporate one or more cores 150, each containing for example a memory management unit (MMU) 200 and data caches 155. MMU 200 may operate based on a variety of mechanisms for implementing and accelerating memory address mappings and translation, such as Translation Caches 210, Page-Table Walkers (PTWs) 215, Translation Lookaside Buffers (TLBs) 205, and the like, as known in the art. Processor 105 also includes one or more memory controllers (MCs) 160 and an IO/coherent link 165 that provide access to memory resources 120a and 120b which may include conventional address translation structures 220 such as Page Tables as known in the art. Memory resources may be located, inter alia, in main memory, far memory, storage memory, and so forth. In particular, memory resources may be or may include a plurality of, possibly different memory units, such as, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory resources 120, may, in principle, be found at any physical location (e.g., inside a personal computer, in an external memory drive, and the like), and may be for example linked with processor 105 via memory controller 160 or IO/coherent link 165, and are subject to memory address translation by MMU 200.

It should be noted that, according to some embodiments of the invention, the above elements may be implemented in a virtualized software framework—e.g., using vCPUs, vCores, vMMUs, vTLBs, and so forth.

A multi-dimensional entropy sampling (MDES) engine 300 may be used to collect entropy data and metadata associated with memory-related events and organize them in a useful manner In possible embodiments of the invention, MDES engine 300 is configured to collect entropy associated with operations by MMU 200 and MC 160 (or IO/coherent link 165), forming an ‘on-CPU’ entropy sampling apparatus, as depicted in FIG. 2. In other embodiments, MDES engine 300 may be configured to collect entropy related data involving memory/coherent interfaces (such as UPI, CCIX or CXL)/accelerators 120c attached to system interfaces, forming an ‘off-CPU’ entropy sampling apparatus, as shown in FIG. 3. Other system embodiments may employ a combination of the aforementioned configurations for MDES engine 300 such that it collects entropy involved with various memory-related components. n

In some embodiments of the invention, MDES engine 300 may receive, sample or collect entropy data describing memory events (e.g., address translation operations by MMU 200, such as page table hits) from their corresponding location in the system's memory and store them in dedicated entropy data structures such as journals, which may be hierarchical. For example, MDES engine 300 may receive data including memory transaction events and store the data multiple data structures, for example according to metadata related to the transaction events (which may itself be stored in the events). Such entropy data structures may vary in size and be further organized in multiple hierarchies. For instance, in some embodiments, some entropy data may be stored as discrete, minimum-size units of entropy elements (EEs) in memory 120. In some other embodiments, entropy data may be organized in more complex structures that include macro-level entropy stores 330 that are further partitioned into data structures such as entropy journals (EJs) 335, each containing a set of entropy records (ERs) which include a plurality of EEs. Entropy data structures may allow collecting entropy data in different dimensions (i.e., spatial and temporal) as explained herein.

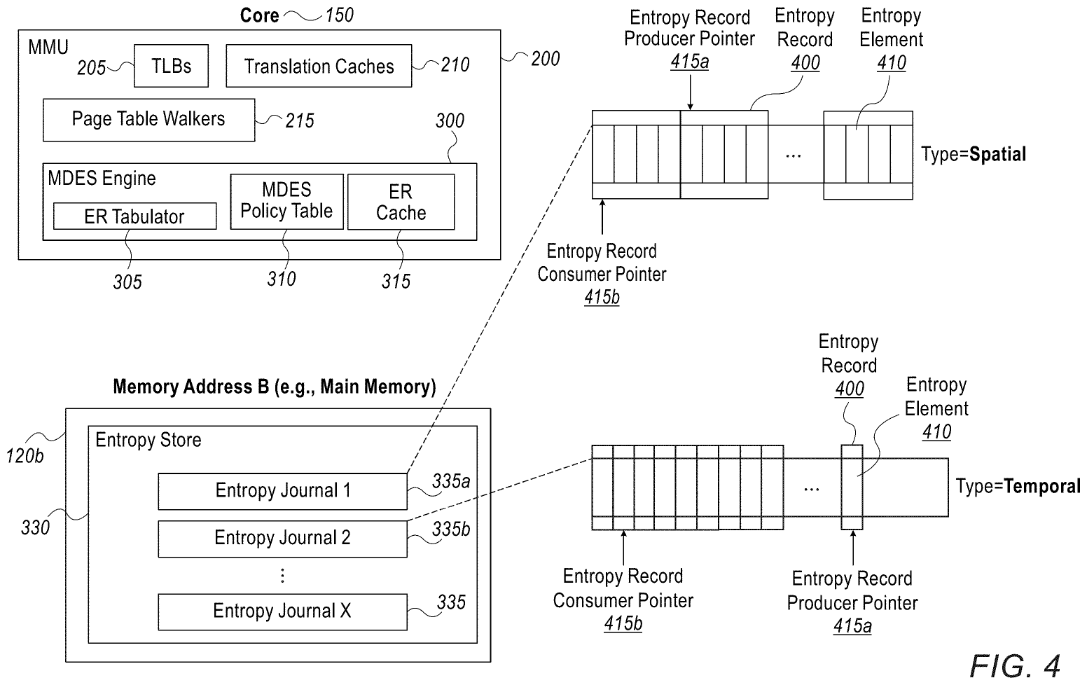

Reference is now made to FIG. 4, illustrating an example entropy sampling apparatus in a processor core, an internal structure for an MDES engine, and an entropy store implementation to be stored in system memory 120 according to some embodiments of the invention. MDES engine 300 is configured to collect, sample or receive entropy data associated with MMU 200 within processor core 150, which also includes Translation Caches 210, PTWs 215, and TLBs 205 as illustrated above regarding FIGS. 2-3.

A given entropy store 330 may be partitioned into EJs 335 which, in turn, may contain one or many ERs 400 ordered in a producer-consumer FIFO (first-in-first-out) fashion that enables a software-entity to track the entropy collected in that EJ. Each ER 400 may include one or more EEs 410. MDES engine 300 may include an ER tabulator 305 which may record the location of an ER within a given EJ, and an ER cache 315 to store ERs for short amounts of time (e.g., in case an ER is to be moved from one EJ to another) and a policy table 310 that may contain conditional rules for sampling and storing ERs as further demonstrated below. While the present example describes tabulator 305, cache 315, and policy table 310 being used for tabulating and storing of ERs, other embodiments may use such components and/or multiple and different data structures, e.g., EEs.

In some embodiments, an ER producer pointer (e.g., ER.Producer) 415a may be configured to point to the ER location (within the EJ) where MDES engine 300 stores new entropy data (e.g., EEs). An ER consumer pointer (ER.Consumer) 415b, on the other hand, may be configured to point to the ER location where backend processing entity, such as software, firmware, or another hardware, reads the entropy data that was previously sampled. The relation between ER.Producer and ER.Consumer may determine a state of the EJ under consideration. For instance, it may determine whether the EJ 335 is in an ‘EMPTY’ state (e.g., no ERs are present in the EJ), in ‘ACTIVE’ state (e.g., entropy data is currently being used by a process or program), or in ‘FULL’ state (e.g., no further ERs can be added).

In some embodiments of the invention, entropy records may be obtained and stored in EJs that correspond to spatial (EJ 335a) or temporal (EJ 335b) sampling schemes, thereby offering a multidimensional perspective on entropy data collection. Spatial sampling is carried out over a particular value space (e.g., a given range of memory addresses). Precision associated with spatial sampling procedures may be adjusted according to the size of the value space associated with it (e.g., large value space corresponds to low precision, small such space to high precision). Temporal Sampling may collect entropy events in a given time domain, such as by their occurrence order. Similarly to spatial sampling, temporal sampling precision may be adjusted according to the length of the time domain in which entropy elements are collected. Both sampling schemes collect or receive entropy data (e.g. memory transaction events or data related to events) into an accumulator array containing # (e.g., space size/quanta) elements, where ‘quanta’ signifies the size of an EE in the sampling procedure. EE size settings may be adjusted or optimized to represent a “sweet spot” between high visibility and informativeness and desirable system performance (e.g., by collecting certain optimal amounts of entropy data within each EE).

In some embodiments of the invention, EEs may be stored in ERs (and ERs may be stored in EJs, which may be stored in entropy stores, etc.) in a particular memory resource available to the system according to a collection of software-defined policies—composed, e.g., by metadata related to memory transaction events stored in policy table 310 in MDES engine 300. Such policies may be triggered by software-defined conditional rules and enable limiting, via policy actions, the sampling process to specific types of entropy data and memory events. In possible embodiments, conditional rules include policy keys that define the set of event properties and metadata required for triggering the sampling of entropy data for a particular event or transaction. In such manner, an optimal number of, e.g., EEs and ERs may be collected such that a desirable amount of system overhead is dedicated to the sampling process; that is, entropy sampling precision may be adjusted at multiple levels based on the number of EEs, ERs, EJs, etc. collected per memory-related event, and based on the size (e.g. quanta) of EEs, in order not to affect the system's performance Properties and metadata that may trigger software-defined policies and policy actions may or may not include entropy data as collected in, e.g., EEs, as well as additional data. Thus, triggering of said policies and policy actions may, for instance, depend on entropy data—which may include telemetry metadata such as: TransactorID tags that identify the initiators of the transaction (e.g., NumaID identifying the processor socket, CoreID identifying a particular processor core, VMid identifying a particular Virtual Machine, PID process identification, PASID identifying a process address space, IOMMUid, and the like). TransacteeID tags that identify the targets of the transaction (e.g., RemoteMemID identifying a remote memory store, DimmID memory component, etc.). Transaction ValueSets in the form of {type,Value}, such as {gVA (guest virtual address), Value}, {hPA (host physical address), Value}, {TransactionSize, #Bytes}, and so forth.

As discussed herein regarding a system monitoring unit, OS 115 may be configured to use entropy data collected and organized by the MDES engine such that, e.g., if an host-virtual-address is requested for a memory transaction, and if that host-virtual-address is currently mapped to a host-physical-address associated with a hot spot, then OS 115 can map that host-virtual-address onto a different host-physical-address via, for example, modifying translation structures, leading to an appropriate translation by MMU 200 as known in the art.

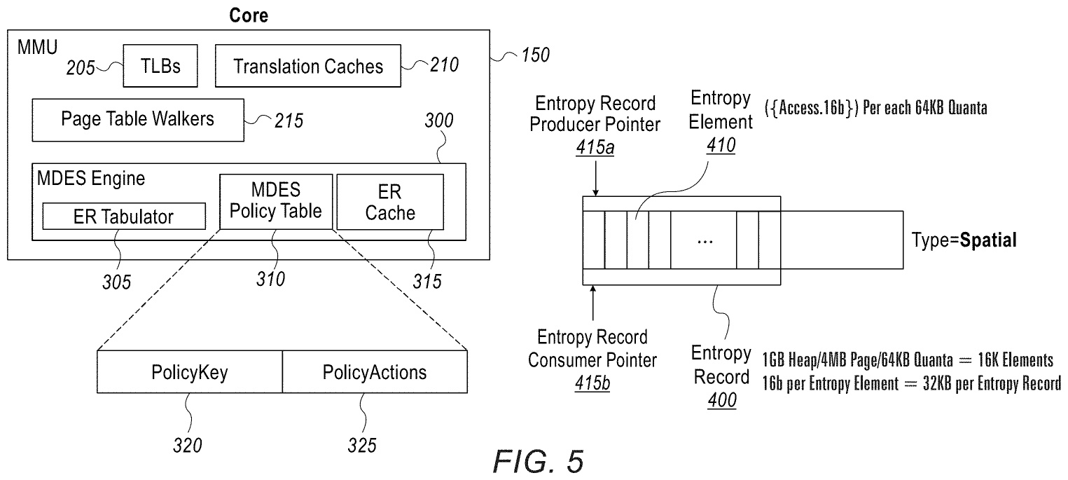

Reference is now made to FIG. 5, which is a block diagram of policy table components which may be used in an entropy sampling apparatus, and an illustration of an entropy sampling procedure according to possible embodiments of the present invention. Policy table 310 may store policy keys 320 and corresponding policy actions 325 that may be triggered to determine the particular sampling schemes, methods, and operations by which entropy data is collected and stored. In some embodiments, policy actions may be executed based on data structures associated with the location where entropy elements are to be stored (e.g., entropy store, an EJ and its associated ER.Producer and ER.Consumer pointers, etc.). Policy actions may further determine the scheme, or type of entropy sampling for a given EJ, namely spatial or temporal.

In the example illustrated in FIG. 5, a memory address space of 1 GB with a quanta of 64 KB would result in an accumulator array of 16K elements. According to some embodiments of the invention, each element in the array may be associated with a policy key 320 and, once it called by MDES engine 300, trigger a entropy data collection and usage policy corresponding to pre-defined rules (e.g., leading to entropy data collection of a given range of memory addresses, or suspending such collection, or slowing down the sampling rate, etc.). Each element may also be associated with a policy to trigger a particular Acc.EventType (e.g., RD, WR) and execute an Acc.AluOp (ALU Operation) with Acc.Value of Acc.Width of bits. For instance, Acc.AluOp may include the operations ADD, ADDs(saturated), SUB, SUBb(bottom).

Given an entropy sampling scheme or type (e.g., spatial or temporal), a sampling method, or rate, can be set to, for example: Always (continuous, e.g. repeatedly); None (sampling disabled); RS (Random Sampling) with sampling probability set by RS.Prob; or PS (Periodic Sampling) according to intervals in PS.Timer within W, where W defines the sampling validity window (e.g., in clock ticks) and where an event that occurred within the window W (e.g., during the last W ticks), is considered valid for the current round of periodic sampling. In order to activate periodic sampling for a given policy key, the key must be associated with a particular PS.Timer. Multiple PS.Timers may be triggered at the same moment. In such case, policy keys associated with these PS.Timers may be processed concurrently. Other sampling methods may be used in other embodiments of the invention.

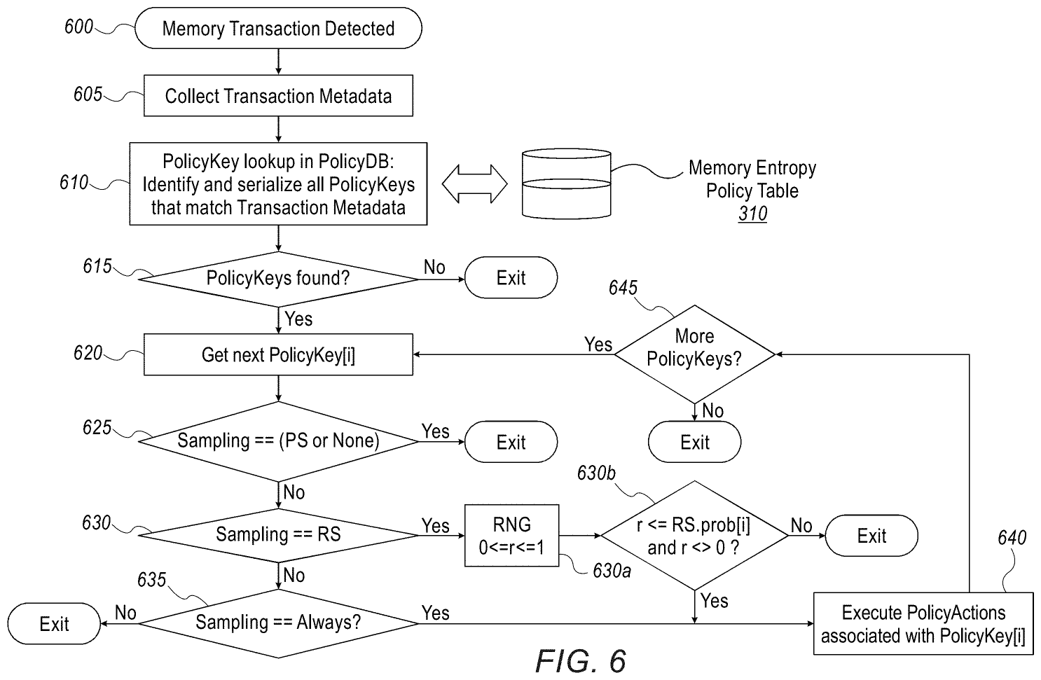

FIG. 6 is a flow diagram illustrating the triggering of software defined policies and policy actions via policy keys—that may be used, e.g., as part of an entropy data collection process. After a given memory transaction (e.g., a memory transaction event or data related to the event) is detected or received in step 600, transaction metadata (which may, e.g., include entropy data) is collected by MDES engine 300 in step 605. In the subsequent step 610, collected metadata may be matched with a corresponding policy key 320 found in the policy tables/database which may be stored in MDES engine 300. A transaction may match a policy if metadata associated with the transaction is equal to or with the range of, or otherwise correlates with a policy key; other types of matching may be used. MDES engine 300 then may check if matching policy keys have indeed been found (step 615). If such policy keys are not found for the metadata under consideration, then no policy action will be triggered (in some embodiments, this may lead to the termination of the entropy data collection process). In step 620, MDES engine 300 searches for additional policy keys as there might be more than one policy key that can be matched with said transaction's metadata. If additional policy keys are found for the metadata under consideration, then once all policy keys have been found, MDES engine 300 may determine whether or not the sampling method associated with a given policy key is, for example, None, or PS (in the case there is no PS.Timer associated with the policy key under consideration (step 625)). If so, no policy action will be triggered; otherwise, in step 630, MDES engine 300 may check whether the policy key is associated with Random Sampling. If so, a random number generator may be used in step 630a to generate a random number r that satisfies 0<r <1. MDES engine 300 will then check if r equals to, or is smaller than the predefined probability RS.prob (step 630b). In the case where r<=RS.prob, no policy action (e.g., sampling of entropy data) may be performed. In the case where r>RS.prob—MDES engine 300 may execute the policy actions associated with the policy key under consideration or that has been matched (e.g., execute spatial sampling, storing ERs in a particular EJs, and so forth in step 640 In some embodiments, policy actions involving, e.g., random sampling may also involve arithmetic and logical operations, e.g., dividing by greater than or equal to/less than, or the converse, greater than/less than or equal to, etc. If the sampling method associated with the policy key is not set to Random Sampling, MDES engine 300 may check whether it is set to Always (step 635). In such case, policy actions (e.g., entropy data sampling) associated with the policy key may then be executed (step 640). Finally, following the executions of policy actions in step 640, MDES engine 300 will check whether there are additional policy keys matching the transaction's metadata (step 645). If so, the program may return to step 620, taking the next policy key into consideration. Otherwise, no additional policy actions will be performed.

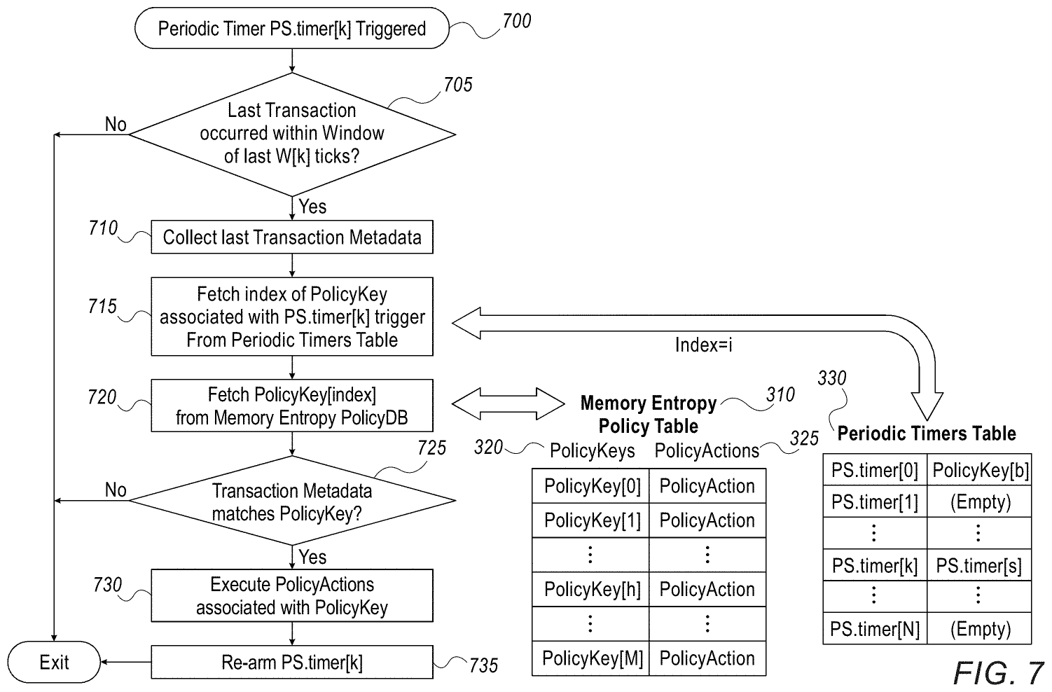

FIG. 7 is a flow diagram illustrating a periodic sampling process involving the triggering of software defined policies according to some embodiments of the present invention. In step 700, a PS.timer may be triggered at clock tick k (e.g., according to a preceding policy action). MDES engine 300 then may check whether a given memory transaction has occurred within the window W of k clock ticks (step 705); e.g. a memory transaction event or data related to the event may be received. If the answer is negative, the transaction/event may be considered as invalid for triggering policy actions, such as entropy data collection. In the positive case, the event may be considered valid, and a corresponding entropy data or metadata collection may be performed for said transaction (step 710). In the subsequent step 715, the index i of a particular policy key, associated with the triggering of the PS.timer under consideration at tick k, may be fetched from a dedicated Periodic Timers table 330 stored in MDES engine 300. Subsequently, the policy key matching index i may be fetched from the policy table 310 (step 720). MDES engine 300 may then check whether the sampled transaction metadata matches that policy key (step 725). If so, then at step 730, MDES engine 300 may execute the corresponding policy actions (e.g., sample entropy data) associated with said policy key. Otherwise, no such action will be performed. Finally, in step 735, PS.timer may be re-armed, or reset, such that it may be used in additional procedures (e.g., periodic sampling associated with different memory transactions or memory addresses).

As noted above, in the example illustrated in FIG. 5, MDES engine 300 may be configured to track and count memory accesses targeting an address range of, for example, 1 GB using quanta of 64 KB (Kbyte). This 1 GB address space may be grouped together to form a single “huge page”, such that an extended TLB Reach may significantly enhance the performance of the application as known in the art, while MDES engine 300 may provide fine grain visibility of entropy data at 64KB quanta into actual memory usage of each of the underlying addresses. In such manner, the OS or similar entities can make decisions regarding the optimal page-size allocations for that memory space. In this particular example, each ER is made of 16K accumulators (1 GB/64 KB quanta). Each Accumulator is 16 bit wide (Acc.Width=16), and is triggered to store entropy data by (Event.Type =Access), as well as execute (Alu.Op =Increment (Saturate)) of (Acc.Value=1).

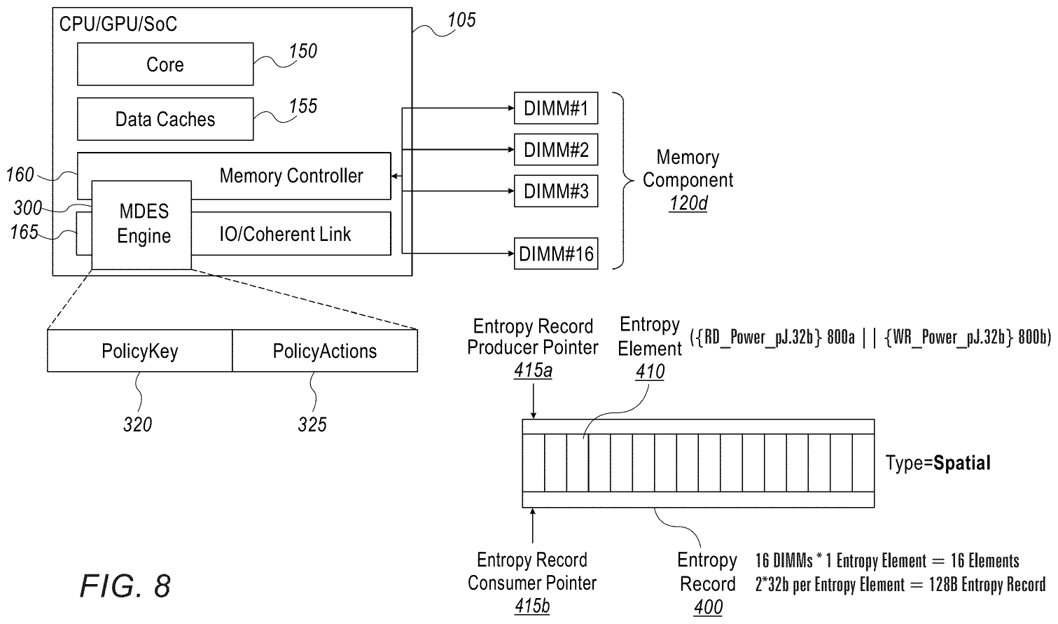

FIG. 8 illustrates an example where MDES engine 300 may be configured to track power consumption estimates 800 (e.g., in pJ, picojoules) for particular memory components (e.g. 16 DIMM component 120d controlled by MC 160 in a computer processor 105), for the purpose of monitoring system health and prevent hot spots that might cause premature failures, according to some embodiments of the invention (e.g. in an on-CPU configuration, as in FIG. 2). When hot spots are detected, OS 115 or a system monitoring module may trigger the altering of memory storage, memory address translation, memory throttling, migrations, and redistributions of memory data contents to other components of the system (e.g., by mapping and unmapping virtual addresses to and from physical ones according to usage patterns extracted from entropy data; see also additional examples elsewhere herein). In such manner, dissipation of heat in the system may be averaged. In the present example, different memory operations are assumed to consume different amounts of energy, such as 23 pJ for RD ops (800a) and 71 pJ for WR ops (800b). Two accumulators of 32 bit each may be set up: one accumulator to sum the energy consumed by RD ops, another accumulator to sum the energy consumed by WR ops. Entropy data stored in these two accumulators may thus be used for preventing hot spots particularly associated with either RD or WR operations, via, e.g., triggering appropriate data migrations to alternative memory resources of the computing system.

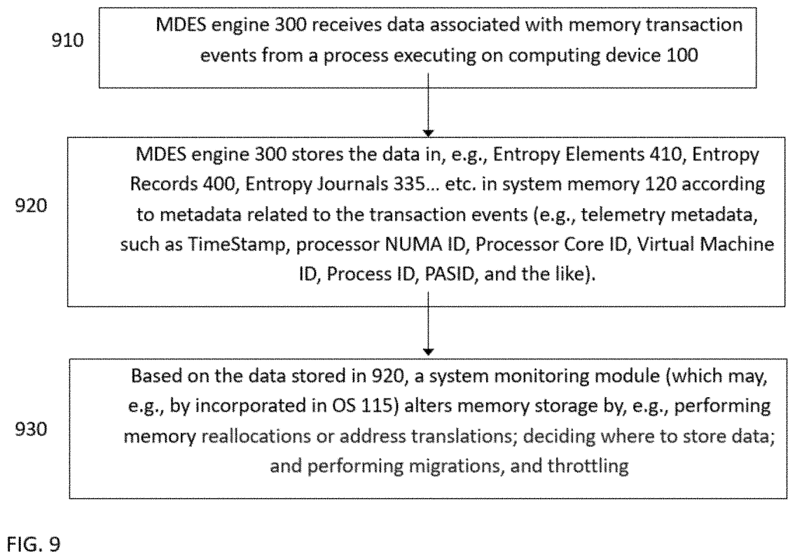

FIG. 9 is a flowchart depicting a process of managing memory resources in a computing system according to some embodiments of the present invention. The operations of FIG. 9 may be performed with data structures or systems as shown in FIGS. 1-8, or with other systems and data structures. In step 910, MDES engine 300 may receive data associated with or describing memory transaction events from a process executing on computing device 100, which may include telemetry metadata as describes herein. This may include receiving or detecting the memory transactions themselves. In step 920, MDES engine 300 stores the data in, e.g., Entropy Elements 410, Entropy Records 400, Entropy Journals 335, and the like, e.g. in system memory 120 according to policies such as those stored in policy table 310 (which may themselves be based on telemetry metadata). In step 930, a system monitoring module (which may, e.g., by incorporated in OS 115) may alter memory storage by, e.g., performing memory reallocations or address translations; deciding where to store data; performing migrations and throttling, and so forth. Embodiments of the invention may include intermediate steps and employ different data or metadata, as well as several system monitoring modules performing different functions or calculations based on the data stored, for example by MDES engine 300 as described herein.

In the description and claims of the present application, each of the verbs, “comprise”, “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In detailed description, some features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

Descriptions of embodiments of the invention in the present application are provided by way of example and are not intended to limit the scope of the invention. The described embodiments comprise different features, not all of which are required in all embodiments. Embodiments comprising different combinations of features noted in the described embodiments, will occur to a person having ordinary skill in the art. Some elements described with respect to one embodiment may be combined with features or elements described with respect to other embodiments. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method of memory management in a computing system, the method comprising:
receiving data comprising memory transaction events; and
storing data related to each transaction event in multiple data structures according to metadata related to the transaction events; and
altering memory storage based on the stored data.

2. The method of claim 1, wherein storing the data is done according to a policy and metadata associated with memory transaction events.

3. The method of claim 2, wherein the policy dictates the rate at which the data is stored.

4. The method of claim 3, wherein the rate is determined at least in part by a random number generator.

5. The method of claim 3, wherein the rate is determined at least in part by a timer or clock ticks.

6. The method of claim 2, wherein the policy determines receiving data associated with a particular memory resource.

7. The method of claim 2, wherein the policy determines storing data in a particular memory resource.

8. The method of claim 1, wherein the data related to each transaction event is collected from internal busses or software transaction parameters associated with an execution unit.

9. The method of claim 1, wherein the data related to each transaction event describes a history of memory transactions for a set of memory resources.

10. The method of claim 1, wherein the data related to each transaction event is not visible to an operating system of the computing device.

11. A system for memory management in a computing system, comprising, using a computer processor:
a memory and;
a processor configured to:
receive data comprising memory transaction events; and
store data related to each transaction event in multiple data structures according to metadata related to the transaction events; and
alter memory storage based on the stored data.

12. The system of claim 11, wherein the processor is configured to store the data according to a policy and metadata associated with memory transaction events.

13. The system of claim 12, wherein the policy dictates the rate at which the data is stored.

14. The system of claim 13, wherein the rate is determined at least in part by a random number generator.

15. The system of claim 13, wherein the rate is determined at least in part by a timer or clock ticks.

16. The system of claim 12, wherein the policy determines receiving data associated with a particular memory resource.

17. The system of claim 12, wherein the policy determines storing data in a particular memory resource.

18. The system of claim 11, wherein the data related to each transaction event is collected from internal busses or software transaction parameters associated with an execution unit.

19. The system of claim 11, wherein the data related to each transaction event describes a history of memory transactions for a set of memory resources.

20. The system of claim 11, wherein the data related to each transaction event is not visible to an operating system of the computing system.
